(19) United States
(12) Patent Application Publication
(10) Pub. No.: US 2009/0188736 A1
(43) Pub. Date: Jul. 30, 2009

(54) Collapsible cooler driven by a remote control controller

(76) Inventors: Saul Niddam, Toronto (CA); Michael Mathieu, Toronto (CA)

Correspondence Address: Paul Lim;Stephen E. Feldman, 16th Floor, 12 East 41st Street, New York, NY, 10017, US

(21) Appl. No.: 12/218,956

(22) Filed: Jul. 21, 2008

Related U.S. Application Data
(60) Provisional application No. 61/062,436, filed on Jan. 26, 2008.

(51) Int. Cl. B62D 1/24; B65D 81/38; B65D 6/16

(52) U.S. Cl. 180/167; 220/592.2; 220/666

(57) ABSTRACT

A remotely driven collapsible cooler apparatus that includes a top ring having at least one handle on its inner side, a latch on its outer side and a bottom plate that includes at least one handle on its inner side, a mating latch on its outer side and a plurality of rotatable and laterally movable wheels, a driven motor, and collapsible storage bag positioned between the proximal top ring and the distal bottom plate, which is expandable. The wheels and the motor being remotely controlled by a remote controller;

### RELATED APPLICATIONS

This application claims the priority of U.S. Provisional Application No. 61/062,436, filed on Jan. 26, 2008.

### BACKGROUND OF THE INVENTION

The present invention is in the technical field of food and beverage storage. Particularly, the present invention is in the field of coolers. In particular, the present invention relates to collapsible coolers that are controlled remotely.

### DESCRIPTION OF THE RELATED ART

Portable collapsible coolers with expandable storage are often used for cold-storing food and beverage. These coolers are not easy to use, carry and move, particularly for physically challenged users. A certain amount physical labor is always required to move these coolers laterally across a floor surface and a user has to lift such a coolec to do that. This activity can be difficult especially for users who are ailing from stiff back pain, severe arthritis. Although collapsible cooler storages are generally light in weight, even lifting and carrying this weight can be difficult for these users. In certain situations, certain users desire a cooler storage that is remotely movable without the user having to lift and move the cooler.

There is a need for a collapsible cooler that doesn't require a user to exert any physical labor for laterally moving it from one place to another and that uses a remote control device for that purpose.

There is also need for a collapsible cooler having a cooler storage that expands and collapses without being restricted by the housing.

### SUMMARY OF THE INVENTION

A remotely driven collapsible cooler apparatus includes an top ring having at least one handle on its inner side, a latch on its outer side and a bottom plate that includes at least one handle on its inner side, a mating latch on its outer side and a plurality of rotatable and laterally movable wheels driven by a motor where the wheels and the motor are enabled by a remote control unit or a remote controller. The cooler has a closed position wherein the latch is engaged with the mating latch and an open position, wherein the latch is not engaged with the mating latch. The collapsible cooler further has a flexible, heat insulative storage bag between the top ring and the bottom plate. The storage bag is expandable beyond the limits defined by the outer peripheries of the top and the bottom plates in an open position. The storage bag has a plurality of attachment straps for strapping the storage bag onto the ring and the bottom plate handle and a top ring for covering the storage bag in an open position. The cooler apparatus further includes a remote controller that controls the motor and the movement of wheels.

A remotely driven collapsible cooler apparatus that includes a base plate having at least one handle on the inner side is provided. The handle provides attachment for a flexible, collapsible storage bag. The remotely driven collapsible cooler apparatus may also include a plurality of indentations on a top surface of the base plate. The plurality of indentations provide for housing for a storage container. The cooler apparatus further includes a motor, and a plurality of rotatable and laterally movable wheels driven by the motor that are placed on a bottom surface of the base plate. The wheels and the motor being enabled to be remotely controlled by a remote controller that controls the motor and the movement of wheels.

The storage bag also has a lid for covering the storage. The cooler apparatus also includes a cover plate that is placed over the base plate and covers the base plate to form a closed storage.

### BRIEF DESCRIPTION OF THE DRAWINGS

The above mentioned and other features, aspects and advantages of the present invention will become better understood with regard to following description, appended claims and accompanying drawings, wherein like reference numerals refer to similar parts throughout the several views where:

FIG. 1A is a front perspective view of a cooler of the present invention in an expanded position;

FIG. 1B is a front perspective view of the cooler of the present invention in a collapsed position;

FIG. 1C is an enlarged top perspective view of a portion of the cooler of the present invention;

FIG. 1D is a top side perspective of the cooler;

FIG. 1E is a top perspective of the cooler;

FIG. 2A is a back perspective view of a bottom plate of the present invention;

FIG. 2B is a top perspective view of a storage bag attached to the bottom plate of the present invention; and

FIG. 3 is a frontal view of a remote control device of the present invention.

### DETAILED DESCRIPTION OF THE INVENTION

Although specific terms are used in the following description for sake of clarity, these terms are intended to refer only to particular structure of the invention selected for illustration in the drawings, and are not intended to define or limit the scope of the invention.

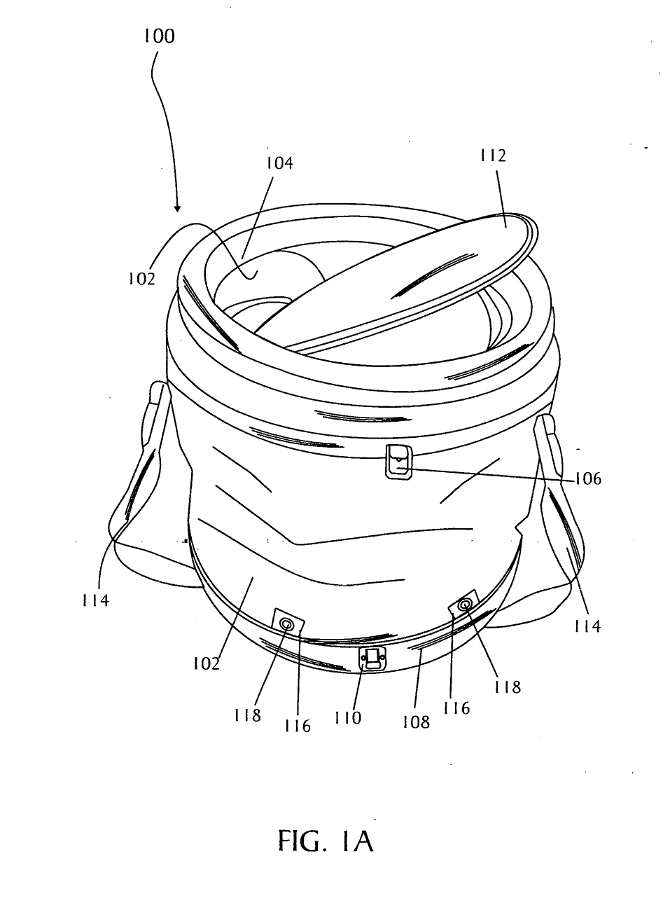

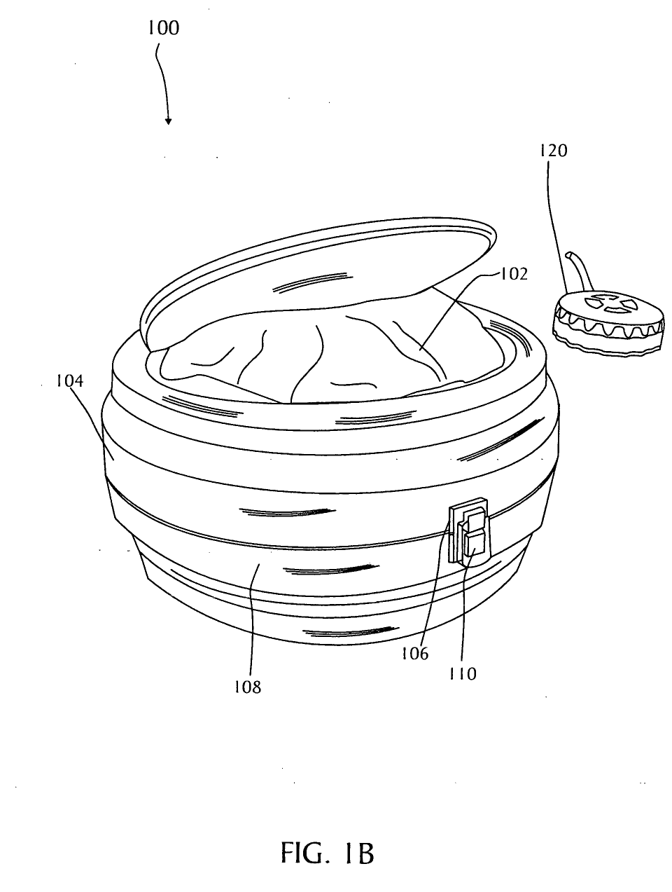

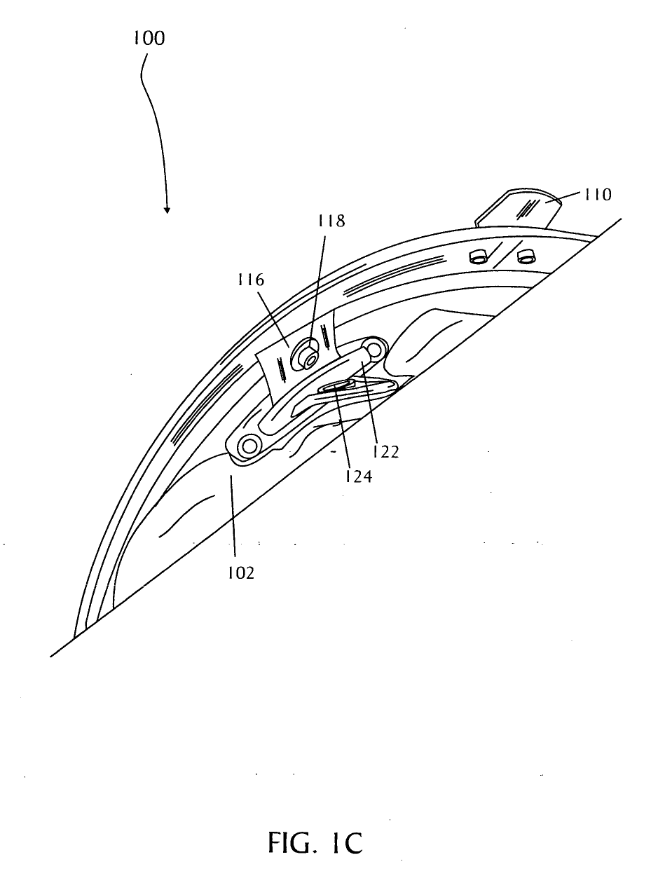

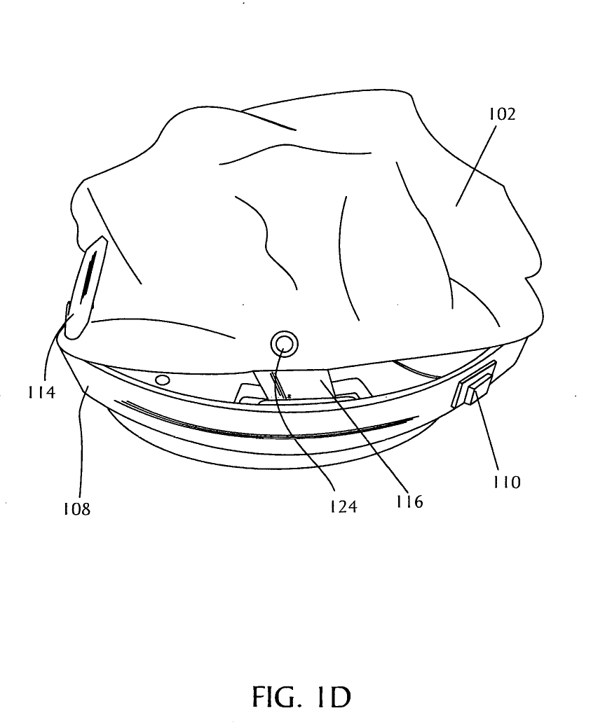

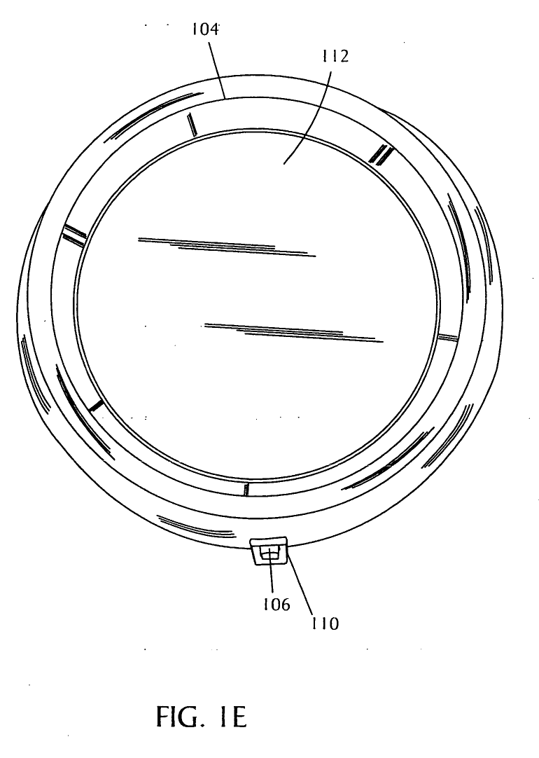

Referring to FIGS. 1A and 1B, there is shown a cooler 100 having a collapsible and expandable storage bag 102, which is connected to a proximal top ring 104 with latches 106 attached at positions around the periphery and a distal bottom plate 108 with mating latches 110 around the periphery. The latches 106, 110 in the top ring 104 and bottom plate 108 are secured to each other to secure the cooler in the collapsed position as shown in FIG. 1B. The top ring 104, which may be hollow or solid, is covered with a top lid 112.

A handle strap 114 is also removably attached on either side of the cooler 100. In a preferred embodiment, the handle strap 114 is comprised of two ends, attached at different positions of the surface of the bag 102. The handle strap 114 is capable of being protruded through a notch in the upper plate when the proximal top ring 104 and distal lower plate 108 are in the collapsed position. The handle strap 114 can also be concealed inside the proximal top ring 104 and distal lower plate 108 when the two are in the collapsed position. The handle strap 114 can be attached or removed in either the collapsed or open position of the cooler 100. These configurations provide for additional utility such as the ability to use the handle strap 114 to hand carry an empty and closed cooler 100 to a fill up location and than to drive it away by remote control when it is full and deployed in the expanded position.

A fiber strap 116 is looped over the handle 122 on the top ring 104 and lower plate 108 housings. In another embodiment, a press-fit component 118 attaches the strap 116 to the storage bag 102. In one embodiment, a combination of the strap 116 and the press-fit component 118 are used to attach the storage bag 102 to the top ring 104 and the bottom plate 108. A remote controller 120 is provided for remotely driving the collapsible cooler 100.

The handle strap 114 is preferably made of strong nylon fabric and is preferably press-fitted into a plastic press-fit component of the storage bag 102. In another embodiment, the handle strap does not have to be used. The storage bag 102 is preferably made of a flexible, expandable, inflatable, and highly insulative, heat material. In one embodiment, the storage bag 102 used is very light in weight. In this one preferred embodiment, the size of the bag is not reducible or enlargeable. However, in yet another embodiment, the size of the storage bags can be either reduced or enlarged by providing zips for this purpose.

Referring now to FIGS. 1C-1E, the attachment of the storage bag 102 to the ring 104 is shown. The storage bag 102 is removably strapped on the handle 122 provided on the ring 104 and the bottom plate 108. The female press-fit component 118 that is preferably stitched with the strap on to the storage bag receives a male press-fit component 124. In one embodiment, the strap material is, but not limited, to fiber. The end of the strap 116 that male component 124 is passed through is the cavity of the handle 122. The male component is 124 is then press-fitted into the female component 116. The use of male and female press fit components 124, 118 to lock the straps 116 and the storage on the plates 104 and 108 facilitates easy removal and replacement of the storage bag 102.

The top lid 112 that is used to cover the storage bag 102 is preferably made of highly insulative material. The top lid 112 may be press-fitted on the top of the storage bag 102. It should be noted, however, that in yet another embodiment, the top lid 112 may be closed by a plastic zipper. In one preferred embodiment, the ring 104, the bottom 108, and the cooler 100 are approximately cylindrical in shape. As shown in FIG. 1D, looking from top, the ring 104 and the top lid 112, which covers the storage bag 102, have an outline that is circular in shape. However, it is understood, that the shape of the outline of ring 104 as well as that of the top lid 112 may vary in other embodiments. Furthermore, the top lid 112 is made of soft, yet strong, stretchable and flexible material.

The combination of the handle 122, the fiber strap 116, and the press-fit component is used to removably attach the storage bag 102 to the bottom plate in one preferred embodiment. However, it should be noted, that other different types of attachment means may be used to attach the storage bag 102 to the ring 104 and the bottom plate 108.

The advantage of using the combination of the strap 116 in conjunction with the press-fit component is that this type of attachment advantageously allows for the use of storage bags of different sizes. Moreover, the feature is especially useful when the user needs to carry large loads of beverages or other such articles. A person just has to keep with them an assortment of different sized storage bags which they can use according to their needs. The storage bag is made of such a material that makes storage bags easily foldable into folds that are very small in size. Therefore, the user can easily keep a good number of storage bags to be used with the cooler. Furthermore, removability of the bag allows for washing of the bag.

The storage bag 102 used in the preferred embodiment is removable and replaceable. However, it should be noted that a storage bag that is neither removable nor replaceable can be used in other embodiments. Further, a storage bag 102 that is permanently attached to the top plate 104 and the bottom plate 108 may be used. For this purpose, the cooler 100 may have fiber straps 116 that are stitched in a permanent loop over the handles 122 on the top ring 104 and bottom plate 108. The cooler may even use a plurality of screws to permanently attach storage bag 102 to the top ring 104 and the bottom plate 108. Furthermore, the cooler 100 may have one standard bag size that only accommodates one fixed volume of beverages. It should also be noted that in yet another embodiment, the cooler 100 may also be used without the storage bag 102 and used merely as a container to carry small items, such as fruits, from one place to another.

Further, the cooler 100 can be used without using the ring 104. This is especially useful when storing large amounts in the storage bag 102. In this case, the user removes the ring 104 and uses the cooler 100 to store objects, such as water packets. Furthermore, the cooler 100 can be used without using the ring 104 and the storage bag. In this case, the user simply removes the ring 104 and the storage bag 102 and replaces the storage bag 102 with any other storage bag or insulated food and beverage container that can be firmly placed on top of the bottom plate 108. Also, in this embodiment, the cooler may be an inflated bag mounted onto a simplified lower distal plate 108. Thus, the remotely driven cooler according to the present invention can be used as a carrier for other storage containers.

In yet another embodiment, use-and-throw storage containers, such as Tetrapaks, can also be used as storage bags. In this preferred embodiment, the bottom plate 108 is cylindrical in shape. However, the bottom plate 108 may come in a variety of shapes. This is especially useful for accommodating storage containers other than storage bag provided with the cooler and the bottom plate 108 can be selected depending upon the shape of the external storage container to be used. Thus, a round bottom plate 108 can be used with an external storage container that is round in shape and a rectangular bottom plate 108 can be used with an external storage that is rectangular in shape. Similarly, the ring 104 can also come in a variety of shapes.

Further, the bottom plates may have additional housing features. These features may be notches, indentations of appropriate shapes and sizes at appropriate places so that the container does not tumble to the ground while the cooler is being remotely driven.

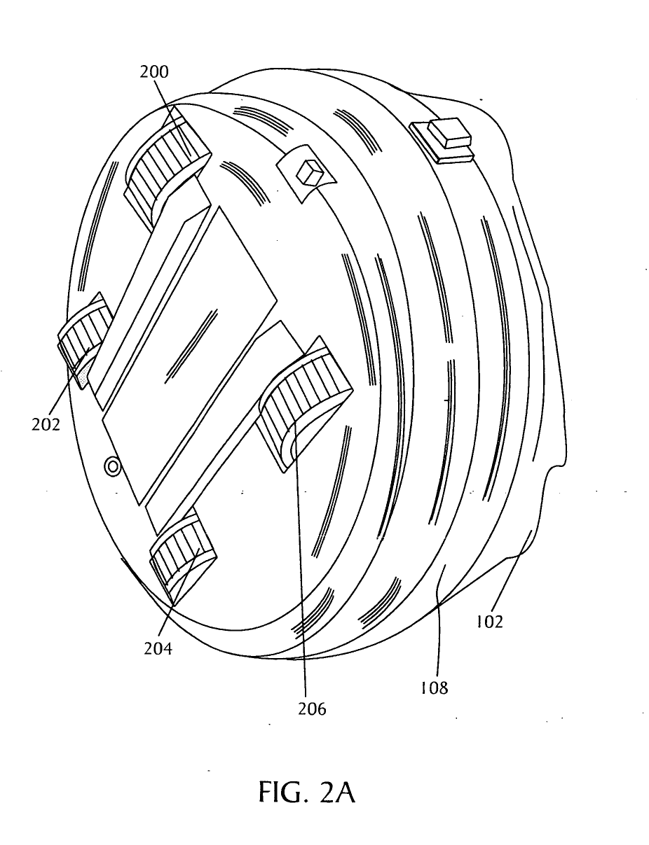

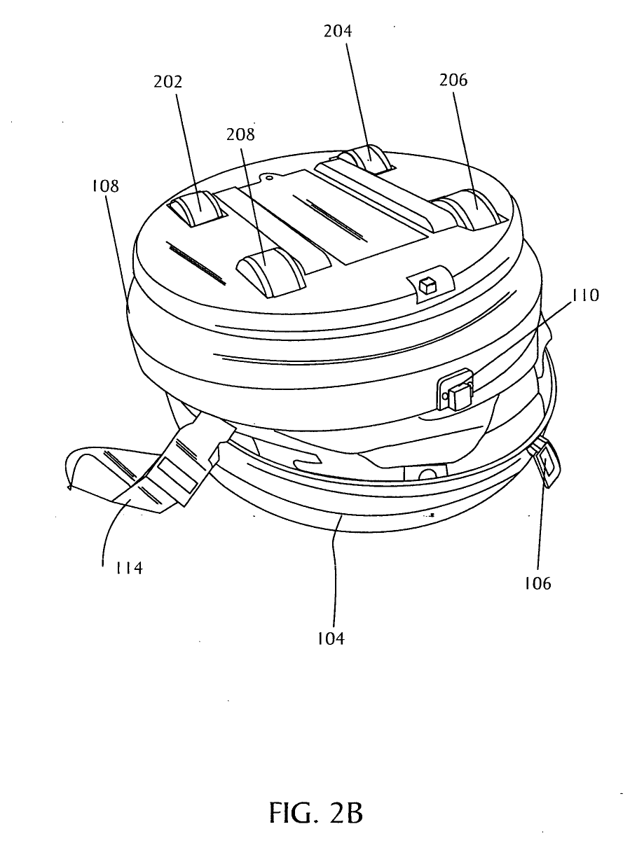

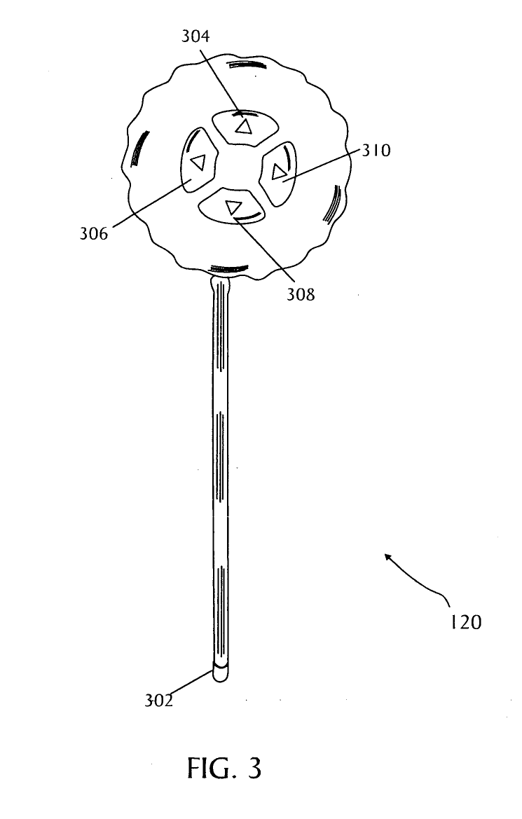

Referring to FIGS. 2A, 2B and 3, the bottom plate or ring 108 is elevated above the floor by four upright wheels, namely a first wheel 200, second wheel 202, third wheel 204, and fourth wheel 206. Each of the wheels 200, 202, 204, and 206 is attached to the underside of the bottom plate 108. A remote control radio frequency controller 120 is used for driving the cooler, which has an antenna 302. The remote controller 120 using a remotely controllable motor (not shown) housed in the bottom plate 108 directs the wheels of the cooler 100. The remote controller 120 in this preferred embodiment is a radio remote control. It should be noted, however, that an infrared remote control may be used in other embodiments.

The cooler 100 may be driven in a horizontal, rotating, or any other axis motion by the wheels which are controlled by the motor (not shown). In one embodiment, the remote controller 120 has four buttons 304, 306, 308 and 310 for horizontally moving the cooler in four different directions. The user is able to move the cooler laterally in any direction by simply pressing these buttons 304, 306, 308, and 310. It is understood, however, that the remote controller 120 may have less or more than four buttons.

In operation, when expanded from the collapsed position, the cooler 100 can be used to store and keep cold food or liquid items such as beer and soda. The cooler 100, however, may also be used to store other items and goods. The flexible storage bag 102 allows the user to store food containers and beverage cans of any shape inside. The user simply pushes the buttons 304, 306, 308, 310 provided on the remote controller 120 to control the movement and the direction of the movement of the collapsible cooler 100 via wheels provided on the bottom plate 108. The use of remote controller 120 to move the collapsible cooler 100 is particularly useful for bedridden persons suffering from ailments such as arthritis and severe backache.

The use of the collapsible cooler is particularly suitable in places such as nursing homes, hospital wards where the users either do not often have the strength to move and lift heavy objects or have been medically advised against exerting any physical labor for lifting and moving heavy objects. The cooler can be used to store critical drugs and medicines that are required to be kept in controlled temperatures. In some cases, the user, such as an ailing patient or someone suffering from a severe stiff back, may not have enough strength to stand up, walk, and open a refrigerator to take medicines. In absence of such help, the cooler may be used to keep the medicines in a refrigerated condition.

However, the cooler may be used for other purposes and by other users also. For example, people who want to watch sports games at home. Similarly, the remotely driven cooler can also be used by a family watching a TV show or having a leisurely conversation. These are just a few examples which highlight the use and utility of the remotely driven cooler.

In one preferred embodiment, the flexibility of the storage bag 102 is not restricted by any solid metal housing. The storage bag 102 can be expanded beyond the limits defined by the periphery of the ring 104 as well as the bottom plate 108. Therefore, the unrestricted flexibility of the storage bag 102 makes storing large and odd sized cans easier as the storage bag is able to take shape or inflate according to the size and the shape of food and beverage items to be stored. On one side, the storage bag provides flexibility in usage, whereas, on another side, the ring and bottom plate 104, 108 provide sturdiness and balance to the collapsible cooler 100 apparatus being moved, particularly when the collapsible cooler is moved laterally, across a floor surface using the remote controller.

Since the collapsible cooler 100 is moved by a remote controller 120, a person does not have to manually carry the cooler around. The handle strap 114, however, allows the cooler to be manually moved around. For example, when the cooler 100 is collapsed, the ring 104 and bottom plate 108 can be attached together with the latches and the cooler carried by the handle strap 114.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

1. A remotely driven collapsible cooler apparatus, comprising:
a proximal top ring;
a distal bottom plate;
at least a handle for either the proximal top ring or the distal bottom plate;
a collapsible storage bag positioned between the proximal top ring and the distal bottom plate, which is expandable and inflatable;
a set of wheels connected to said bottom plate, and a motor for driving said wheels, the wheels and the motor being remotely controlled by a remote controller.

2. The collapsible cooler of claim 1, wherein the storage bag has a plurality of attachment straps for strapping the storage bag onto the top and the ring handles and a top lid for covering the storage bag in an open position.

3. The collapsible cooler of claim 2, wherein the attachment straps include a plurality of press fit components for locking the storage bag strapped onto the handle.

4. The collapsible cooler of claim 2, wherein the attachment straps are stitched in a permanent loop.

5. The collapsible cooler of claim 1, wherein the storage bag further includes at least one detachable handle strap for carrying the collapsible cooler apparatus.

6. The collapsible cooler of claim 1, wherein the storage bag has zips that are adapted to alter the size of the storage bag.

7. The collapsible cooler of claim 1, wherein the bag is heat insulated.

8. The collapsible cooler of claim 1, wherein the bag is removable.

9. A remotely driven collapsible cooler apparatus, comprising:
a base plate that includes at least one handle on its inner side that provides attachment for a flexible storage bag, the base plate forming a housing for a storage container, said base plate having a top surface having a plurality of indentations on said top surface;
a motor, and a plurality of rotatable and laterally movable wheels driven by the motor that are placed on the bottom surface of the base plate, the wheels and the motor being adapted to be remotely controlled; and
a remote controller that remotely controls the motor and the movement of wheels.

10. The collapsible cooler of claim 9, further comprising:
a removable, replaceable, flexible, and heat insulated storage bag attached to the handle(s) of the base plate and that is expandable beyond the limits defined by the outer periphery of the base plate open position, the storage bag having a plurality of attachment straps for strapping the storage bag to at least the base plate and a top lid for covering the storage.

11. The collapsible cooler of claim 9, further comprising:
a cover plate that is placed over the base plate and covers the base plate to form a closed storage.

12. The collapsible cooler of claim 9, wherein the storage further comprises zips.

13. The collapsible cooler of claim 9, further comprising:
a storage container placed within boundaries defined by the plurality of indentations on the bottom plate.

14. The collapsible cooler of claim 1, wherein in a closed position, the latch is engaged with the mating latch, and wherein in an open position, the latch is not engaged with the mating latch.

15. The collapsible cooler of claim 1, wherein the ring includes at least one handle on an inner side of said top plate and a latch on an outer side of said top plate

16. The collapsible cooler of claim 1, wherein the distal plate includes at least one handle on an inner side, a mating latch on an outer side, and a plurality of rotatable and laterally movable wheels driven by the motor.

17. The collapsible cooler of claim 1, wherein the remote controller is a radio remote controller.

18. The collapsible cooler of claim 1, wherein the remote controller is an infrared remote controller.
